(19) United States
(12) Patent Application Publication
(10) Pub. No.: US 2018/0302585 A1
(43) Pub. Date: Oct. 18, 2018

(54) ENDOSCOPE APPARATUS AND MEASURING METHOD

(71) Applicant: OLYMPUS CORPORATION, Tokyo (JP)

(72) Inventor: Tsuyoshi FURUHATA, Tokyo (JP)

(73) Assignee: OLYMPUS CORPORATION, Tokyo (JP)

(21) Appl. No.: 15/949,237

(22) Filed: Apr. 10, 2018

(30) Foreign Application Priority Data
Apr. 13, 2017 (JP) 2017-079568
Mar. 1, 2018 (JP) 2018-036215

(51) Int. Cl. H04N 5/445; H04N 5/232

(52) U.S. Cl. CPC H04N 5/445; H04N 2005/2255; H04N 5/23293

(57) ABSTRACT

An endoscope apparatus includes an image sensor configured to pick up an image of an object, a display configured to display an endoscope image acquired by picking up the image of the object by means of the image sensor, and a controller configured to read, from a memory, measurement positions for measuring the object and display the measurement positions with the endoscope image on the display.

### CROSS REFERENCE TO RELATED APPLICATIONS

This application is based upon and claims the benefit of priority from the Japanese Patent Applications No. 2017-079568, filed on Apr. 13, 2017 and No. 2018-036215, filed on Mar. 1, 2018; the entire contents of which are incorporated herein by reference.

### BACKGROUND

### 1. Technical Field

The present invention relates to an endoscope apparatus and a measuring method.

### 2. Background Art

In the related art, an endoscope apparatus capable of measuring an object is provided. For example, Japanese Patent Application Laid-Open Publication No. 2002-203248 discloses a measuring processing apparatus in which a target region in a predetermined size is set in a measurement object image obtained by picking up an image of a measurement object and the inside of the target region is measured by pattern matching based on a prepared reference image.

In the measuring processing apparatus of the related art, however, preparation of the reference image used for pattern matching requires a lot of time and effort, making it difficult to efficiently detect a crack, a chip, a deterioration, or an abnormality, e.g., a production defect that may occur on an entire object or a part of the object.

Thus, an object of the present invention is to provide an endoscope apparatus and a measuring method so as to efficiently detect an abnormality that may occur on an entire object or a part of the object.

### SUMMARY

An endoscope apparatus according to an aspect of the present invention includes an image sensor configured to pick up an image of an object, a display configured to display an endoscope image acquired by picking up the image of the object by means of the image sensor, and a controller configured to read, from a memory, measurement positions for measuring the object and display the measurement positions with the endoscope image on the display.

A measuring method according to an aspect of the present invention includes the steps of: picking up the image of the object by means of the image sensor, displaying the endoscope image on the display, the endoscope image being acquired by picking up the image of the object by means of the image sensor, and reading, from a memory, the measurement positions for measuring the object and displaying the measurement positions on the endoscope image on the display.

### BRIEF DESCRIPTION OF THE DRAWINGS

FIG. 1 is a block diagram showing a configuration example of an endoscope apparatus according to a first embodiment of the present invention;

FIG. 2 is a diagram showing an example of a folder hierarchical structure of the endoscope apparatus according to the first embodiment of the present invention;

FIG. 3 is a flowchart showing an example of measuring processing of the endoscope apparatus according to the first embodiment of the present invention;

FIG. 4 is a diagram showing an example of measurement points in an endoscope image of the endoscope apparatus according to the first embodiment of the present invention;

FIG. 5 is a diagram showing an example of the measurement points in the endoscope image of the endoscope apparatus according to the first embodiment of the present invention;

FIG. 6 is a diagram showing an example of predetermined search regions in the endoscope image of the endoscope apparatus according to the first embodiment of the present invention;

FIG. 7 is a diagram showing an example of a partially enlarged image in the endoscope image of the endoscope apparatus according to the first embodiment of the present invention;

FIG. 8 is a diagram showing an example of partially enlarged images in the endoscope image of the endoscope apparatus according to the first embodiment of the present invention;

FIG. 9 is a flowchart showing an example of measuring processing on the endoscope image of the endoscope apparatus according to modification 1 of the first embodiment of the present invention;

FIG. 10 is a diagram showing an example of measurement point candidates in the endoscope image of the endoscope apparatus according to modification 1 of the first embodiment of the present invention;

FIG. 11 is a diagram showing an example of an additional setting of the measurement point in the endoscope image of the endoscope apparatus according to modification 1 of the first embodiment of the present invention;

FIG. 12 is a flowchart showing an example of measuring processing in the endoscope image of the endoscope apparatus according to modification 2 of the first embodiment of the present invention;

FIG. 13 is a diagram showing an example of a measurement point candidate in the endoscope image of the endoscope apparatus according to modification 2 of the first embodiment of the present invention;

FIG. 14 is a flowchart showing an example of a measuring processing of the endoscope apparatus according to modification 3 of the first embodiment of the present invention;

FIG. 15 is a diagram showing an example of a folder hierarchical structure of an endoscope apparatus according to a second embodiment of the present invention;

FIG. 16 is a diagram showing an example of a folder hierarchical structure of the endoscope apparatus according to modification 1 of the second embodiment of the present invention; and

FIG. 17 is a diagram showing an example of the folder hierarchical structure of the endoscope apparatus according to modification 1 of the second embodiment of the present invention.

### DETAILED DESCRIPTION OF THE PREFERRED EMBODIMENTS

Embodiments of the present invention will be described below with reference to the accompanying drawings.

### Configuration

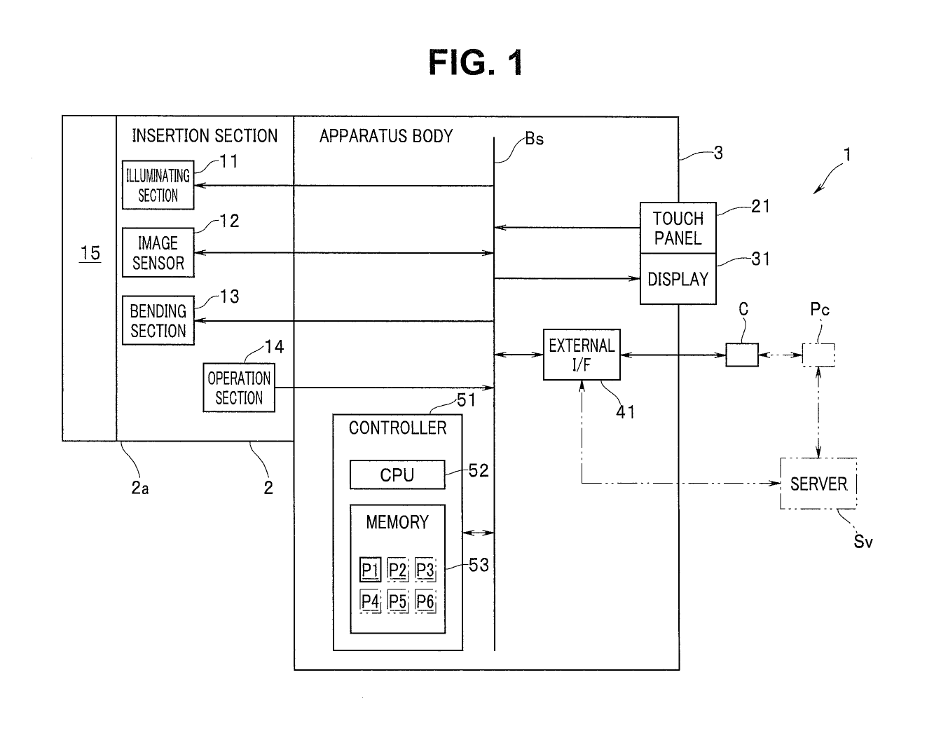

FIG. 1 is a block diagram showing a configuration example of an endoscope apparatus 1 according to a first embodiment of the present invention.

The endoscope apparatus 1 includes an insertion section 2 and an apparatus body 3. A memory card C can be removably mounted in the endoscope apparatus 1. Respective sections in the endoscope apparatus 1 are connected to one another via internal wiring Bs.

The insertion section 2 is formed in an elongated shape and is configured to be inserted into an object from a distal end portion 2a side. A proximal end of the insertion section 2 is removably connected to the apparatus body 3. The insertion section 2 includes an illuminating section 11, an image sensor 12, a bending section 13, an operation section 14, and an optical adapter 15.

The illuminating section 11 is configured to illuminate the object. The illuminating section 11 includes, for example, a light-emitting device, e.g., an LED. The illuminating section 11 is connected to a controller 51 of the apparatus body 3 and emits illumination light to the object from the distal end portion 2a under the control of the controller 51.

The image sensor 12 is configured to pick up an image of the object. The image sensor 12 includes, for example, an image pickup device, e.g., a CCD or a CMOS and an image pickup optical system, e.g., a lens disposed on a side of an image pickup surface of the image pickup device. The image sensor 12 is connected to the controller 51 and picks up an image of the object to acquire an object image under the control of the controller 51.

The bending section 13 is provided on the proximal end side of the distal end portion 2a. The bending section 13 is connected to a bending driving section, which is not shown, via a wire. The bending section 13 bends the insertion section 2 by advancing and retracting the wire under the control of the controller 51.

The operation section 14 is configured to input an instruction. The operation section 14 includes various operation instruments such as a joystick, a freeze button, a record instruction button, and an up, down, left, and right directional bending button, which are not shown. The operation section 14 is connected to the controller 51 and outputs a control signal to the controller 51 in response to the input of the instruction. That is, the operation section 14 is an instruction input section.

The optical adapter 15 is removably attached to the distal end portion 2a. The optical adapter 15 can be replaced with various adapters according to the object. The optical adapter 15 is, for example, an adapter for measurement. The optical adapter 15 projects two object images to the image sensor 12 with a parallax relative to each other. That is, the image sensor 12 acquires the object images with the parallax by means of the optical adapter 15.

The apparatus body 3 includes a touch panel 21, a display 31, an external I/F 41, and the controller 51.

The touch panel 21 is configured to input an instruction. The touch panel 21 is superimposed and disposed on the display 31 and outputs a control signal to the controller 51 in response to the input of the instruction. That is, the touch panel 21 is an instruction input section.

The display 31 includes, for example, an LCD. The display 31 displays various images such as an endoscope image acquired by picking up an image of the object by means of the image sensor 12.

The external I/F 41 can be connected to the memory card C.

The controller 51 is configured to control various operations in the endoscope apparatus 1 and perform various kinds of image processing. The controller 51 includes a CPU 52 and a memory 53 where reading and writing are performed by the CPU 52.

The CPU 52 can perform various kinds of processing. The functions of the controller 51 can be performed by executing various programs by means of the CPU 52. The programs are stored in the memory 53.

The memory 53 includes RAM and rewritable flash ROM. In addition to the various programs and various kinds of data, a program of a measuring processing portion P1 is stored in the memory 53.

The measuring processing portion P1 performs measuring processing such that a measurement position for measuring the object is read from a memory and the measurement position on the endoscope image is displayed on the display 31. More specifically, the measurement position is coordinate information on a measurement point, and the measuring processing portion P1 displays a measurement point image at the measurement position on the endoscope image. Hereinafter, “coordinate information on the measurement point” or “measurement point image” will be simply referred to as “measurement point”.

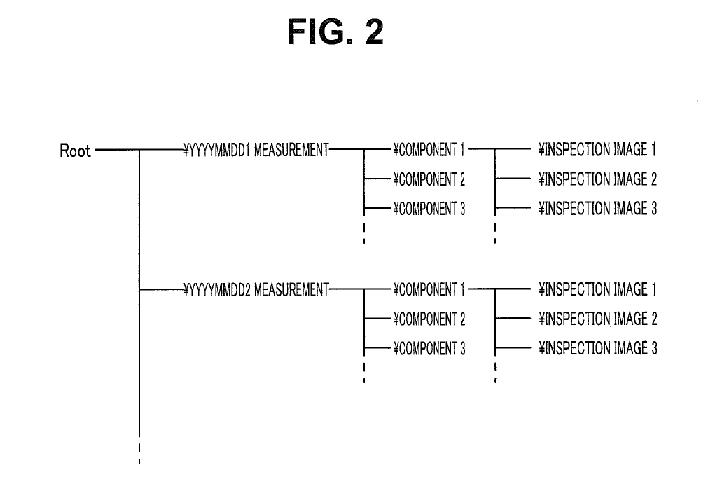

FIG. 2 is a diagram showing an example of a folder hierarchical structure of the endoscope apparatus 1 according to the first embodiment of the present invention.

The memory card C is configured to store measurement information. The memory card C placed into the apparatus body 3 is connected to the external I/F 41, allowing the controller 51 to read and write the memory card C. That is, the memory card C is a memory.

As shown in FIG. 2, the memory card C includes folders of the hierarchical structure and stores the measurement information acquired by the measuring processing. For example, in FIG. 2, upper folders created with folder names of “YYYYMMDD1 measurement” and “YYYYMMDD2 measurement” (YYYY indicates a year, MM indicates a month, and DD indicates a day) for an inspection date YYYYMMDD are placed under “Root”. Moreover, each of the upper folders has lower folders created with folder names “component 1”, “component 2”, and “component 3” for component names. Each of the lower folders stores endoscope image files created with file names “inspection image 1”, “inspection image 2”, and “inspection image 3” for the object. The endoscope image file also includes, for example, the measurement point as meta information. Note that the folder hierarchical structure of FIG. 2 is merely exemplary and does not limit the present invention. That is, the measurement information is stored in the memory card C associated with the inspection date, the component name, and the object.

That is, the measurement position is stored in the memory by the measuring processing portion P1, the measurement position stored in the memory in the past is read from the memory by the measuring processing portion P1, and then the measurement position on the endoscope image is displayed on the display 31.

### Operations

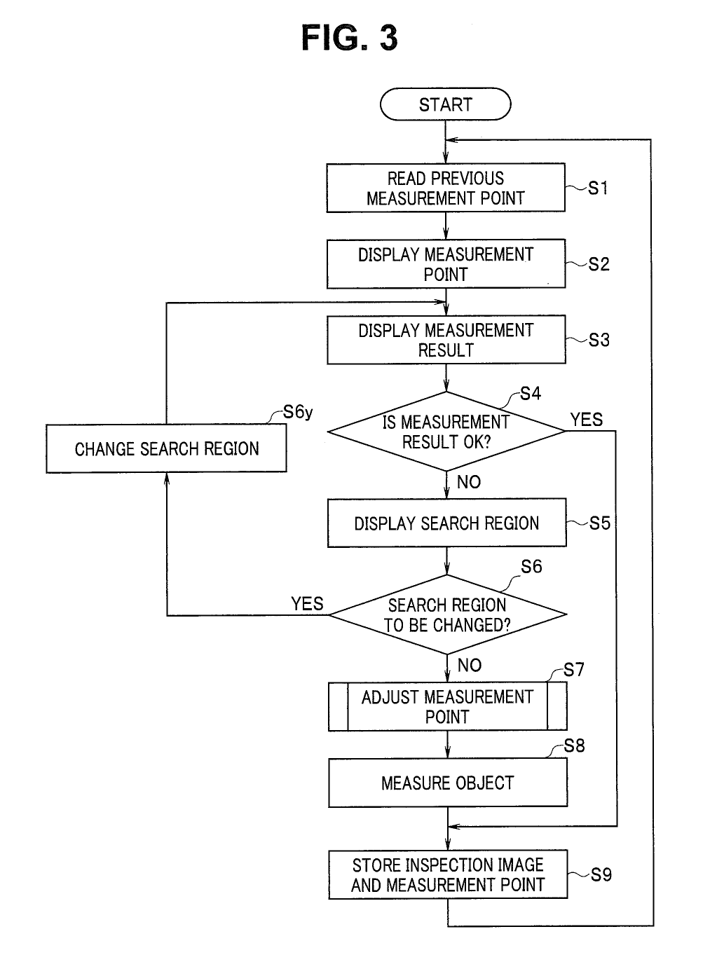

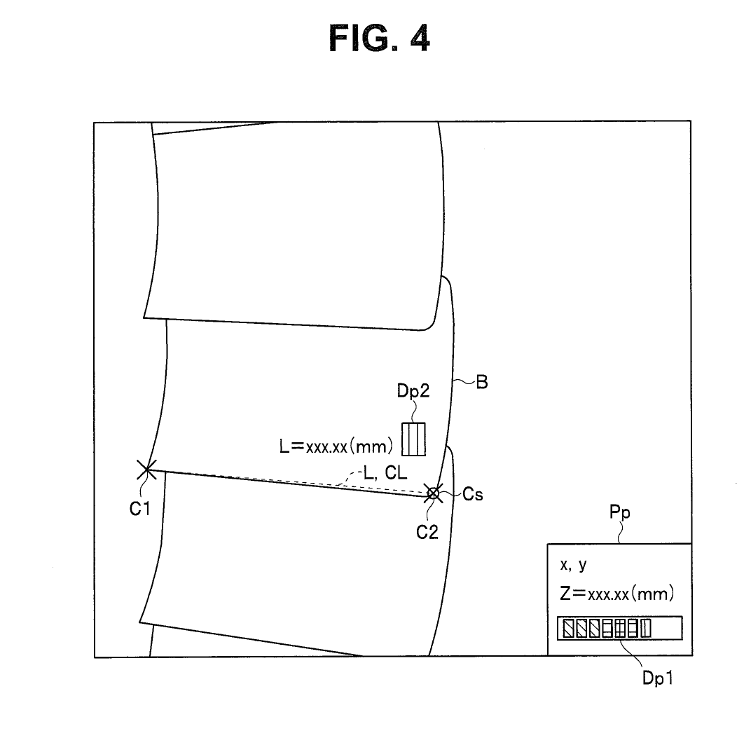

Operations of the endoscope apparatus 1 will be described below. FIG. 3 is a flowchart showing an example of the measuring processing of the endoscope apparatus 1 according to the first embodiment of the present invention. FIG. 4 is a diagram showing an example of measurement points C1 and C2 in the endoscope image of the endoscope apparatus 1 according to the first embodiment of the present invention.

In the example of the endoscope image of FIG. 4, turbine blades B, a cursor Cs, the measurement points C1 and C2, a distance L between the measurement points, a position information panel Pp, and indicators Dp1 and Dp2 are displayed.

When a user inputs an instruction to start measuring by means of an instruction input section, the controller 51 reads the program of the measuring processing portion P1 from the memory 53, executes the program of the measuring processing portion P1, and performs the measuring.

The controller 51 drives the image sensor 12. The optical adapter 15 projects the two object images to the image sensor 12 with a parallax relative to each other. After various kinds of image processing, the controller 51 outputs the two object images to the display 31 and displays the endoscope image on the display 31 based on the object images. FIG. 4 is a display example of the endoscope image based on one of the two object images. Note that the controller 51 may display the endoscope image on the display 31 based on preset one of the two object images.

The controller 51 places the cursor Cs in the endoscope image. The cursor Cs moves in response to the input of an instruction to the instruction input section.

The controller 51 calculates a spacing distance Z from the image sensor 12 at the cursor Cs to the object by a triangulation operation that uses the two object images.

The controller 51 displays the coordinates (“x, y” in FIG. 4) of the cursor Cs, the spacing distance Z, and the indicator Dp1 in the position information panel Pp.

The indicator Dp1 indicates the spacing distance Z according to the number of rectangles. For example, in the indicator Dp1, the number of displayed rectangles increases with the spacing distance Z. In the example of FIG. 4, the indicator Dp1 is configured to display up to three green rectangles, three yellow rectangles, and three red rectangles. According to the spacing distance Z, the three green rectangles, the three yellow rectangles, and one of the red rectangles are displayed, and the other two red rectangles are not displayed.

The indicator Dp2 indicates the spacing distance Z with the colors of rectangles. For example, in the indicator Dp2, the rectangles turn green, yellow, and red according to the spacing distance Z. In the example of FIG. 4, the indicator Dp2 displays red rectangles.

That is, in order to easily place a measured portion of the object at the measurement position, the measuring processing portion P1 calculates the spacing distance Z from the image sensor 12 at the measurement position to the object according to a predetermined arithmetic operation based on the object including a parallax, and then the measuring processing portion P1 displays the spacing distance Z on the display 31.

Subsequently, a first measuring will be described below. In the first measurement, the measurement points C1 and C2 are set. The user moves the object so as to place the object at a predetermined measurement position on the endoscope image. For example, the user rotates and moves the turbine blades B by means of a turning tool, which is not shown, such that the turbine blade B is disposed at the predetermined measurement position. Note that the user may move the image sensor 12 by using the bending section 13 or an image sensor moving mechanism, which is not shown. Moreover, the user may manually move one of the object and the insertion section 2. Furthermore, the user may set the measurement points C1 and C2 by inputting coordinates through the instruction input section.

The controller 51 calculates three-dimensional positions of the measurement points C1 and C2 according to the predetermined arithmetic operation, calculates a distance L between the measurement points, and then displays the distance L on the display 31. Moreover, the controller 51 writes the measurement points C1 and C2 in an endoscope image file and stores the endoscope image file in a predetermined folder in the memory card C.

That is, the measuring processing portion P1 calculates the distance between the measurement positions, which is a distance between a plurality of measurement positions, according to the predetermined arithmetic operation and displays the distance between the measurement positions on the display 31.

In the case of multiple objects, for example, in the case of the multiple turbine blades B, the first measuring is performed on each of the objects.

Second and subsequent measurements will be discussed below.

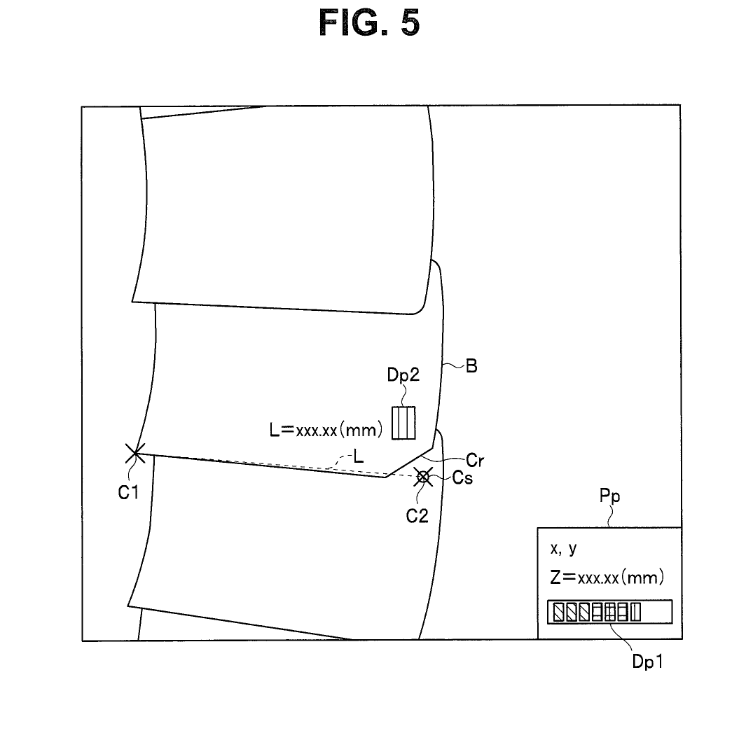

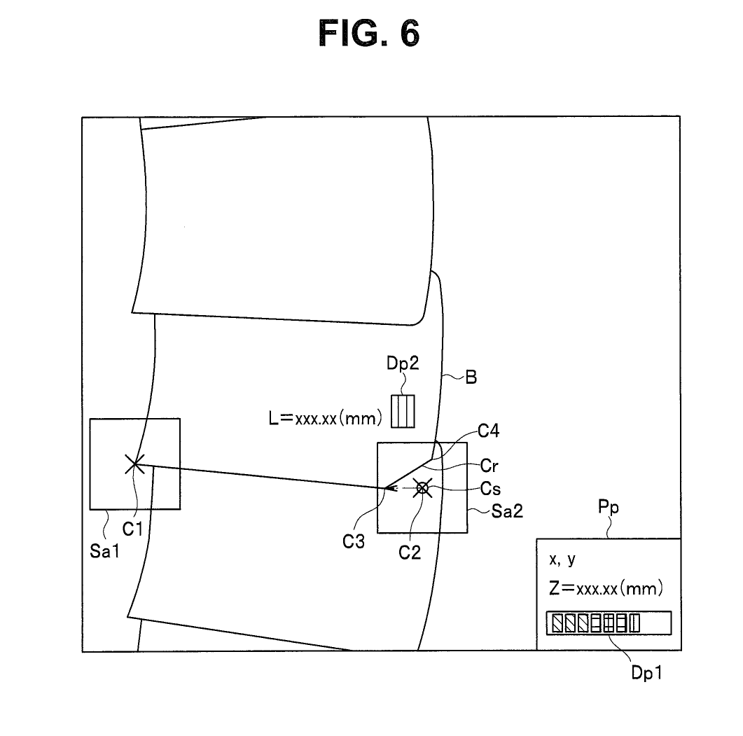

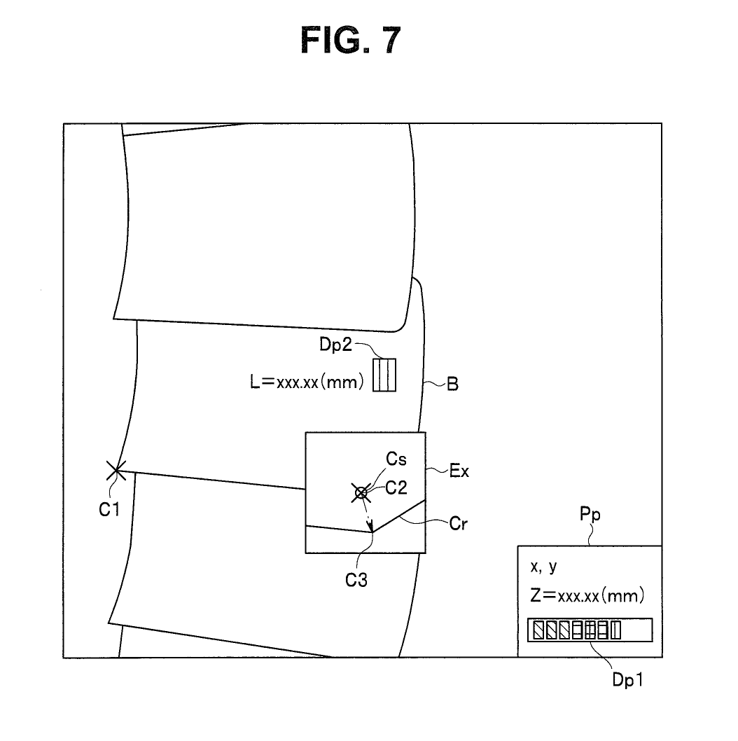

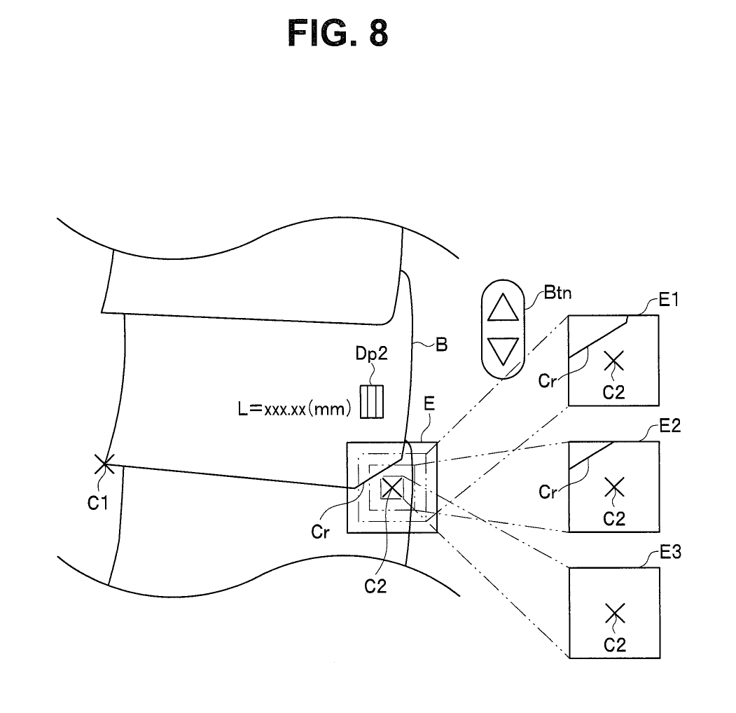

FIGS. 5 to 9 are diagrams showing an endoscope image of the endoscope apparatus 1 according to the first embodiment of the present invention. FIG. 5 shows an example of the measurement points C1 and C2. FIG. 6 shows an example of predetermined search regions Sa1 and Sa2. FIGS. 7 and 8 show examples of a partially enlarged image E.

The previous measurement points C1 and C2 are read (S1). The controller 51 reads the previously stored measurement points C1 and C2 from the memory card C.

The measurement points C1 and C2 are displayed (S2). The controller 51 displays the measurement points C1 and C2, which are acquired in S1, on the display 31.

A measurement result is displayed (S3). The controller 51 calculates the spacing distance Z at the cursor Cs according to the predetermined arithmetic operation and calculates the distance L between the measurement points. The controller 51 displays the cursor Cs, the spacing distance Z, the indicators Dp1 and Dp2, and the distance L between the measurement points as the measurement result on the display 31. The user moves the object so as to place the object at the predetermined measurement position on the endoscope image based on the measurement result of the object the indicators Dp1 and Dp2 displayed on the display 31, for example. According to the movement of the object, the controller 51 updates the measurement result displayed on the display 31.

It is decided whether the measurement result is OK or not (S4). The user visually checks the measurement result and inputs an instruction on whether the measurement result is OK or not through the instruction input section. If the inputted instruction indicates that the measurement result is OK (S4: YES), processing advances to S9. If the inputted instruction indicates that the measurement result is not OK (S4: NO), the processing advances to S5.

For example, as shown in FIG. 4, when the measurement points C1 and C2 displayed in S2 are superimposed and disposed on the measurement position on the turbine blade B, the user inputs an instruction indicating that the measurement result is OK. In contrast, as shown in FIG. 5, when the turbine blade B has damage Cr and the measurement point C2 is not superimposed and disposed on the measurement position on the turbine blade B, the user inputs an instruction indicating that the measurement result is not OK.

The predetermined search regions Sa1 and Sa2 are displayed (S5). The controller 51 displays the predetermined search regions Sa1 and Sa2 centered around the measurement points C1 and C2, respectively, on the endoscope image.

It is decided whether to change the predetermined search regions Sa1 and Sa2 (S6). The user visually checks the predetermined search regions Sa1 and Sa2 displayed in S5 and inputs, through the instruction input section, an instruction on whether to change the predetermined search regions Sa1 and Sa2. If the inputted instruction indicates that the predetermined search regions Sa1 and Sa2 should not be changed (S6: NO), processing advances to S7. If the inputted instruction indicates that the predetermined search regions Sa1 and Sa2 should be changed (S6: YES), the processing advances to S6y.

The predetermined search regions Sa1 and Sa2 are changed (S6y). If an instruction to move the measurement points C1 and C2 is inputted to the instruction input section, the controller 51 changes the predetermined search regions Sa1 and Sa2 in response to the input of the instruction. When the instruction is inputted to the instruction input section, the controller 51 scales up or down the predetermined search regions Sa1 and Sa2. FIG. 7 shows an example of the partially enlarged image E of the predetermined search region Sa2. Note that the magnification of the partially enlarged image E may be changed in response to an operation of the instruction input section on, for example, an operation image Btn (partially enlarged images E1, E2, and E3 in FIG. 8).

The measurement points are adjusted (S7). The controller 51 detects measurement point candidates C3 and C4 in the predetermined search regions Sa1 and Sa2. For example, as shown in FIG. 6, the controller 51 extracts object edges from the endoscope image in the predetermined search regions Sa1 and Sa2 and then extracts characteristic portions such as edge corners as the measurement point candidates C3 and C4. Subsequently, the controller 51 displays the measurement point candidates C3 and C4 on the endoscope image. When the user inputs an instruction to select the measurement point candidate C3, the measurement point C2 is canceled and the measurement point C3 is newly set.

That is, the measuring processing portion P1 sets the predetermined search regions in the endoscope image, detects the measurement position candidates in the predetermined search regions, and displays the measurement position candidates on the display 31. The measuring processing portion P1 can display the partially enlarged image E of the endoscope image including the measurement positions. The areas of the predetermined search regions change according to the magnification of the partially enlarged image E.

The object is measured (S8). Based on the measurement points C1 and C3, the controller 51 calculates the spacing distance Z according to the predetermined arithmetic operation, calculates the distance L between the measurement points, and displays the cursor Cs, the spacing distance Z, the indicators Dp1 and Dp2, and the distance L between the measurement points on the display 31.

The inspection image and the measurement points are stored (S9). In response to the input of the instruction from the user, the controller 51 writes the measurement points C1 and C3 as a measurement result in the endoscope image and stores the endoscope image as the inspection image in the predetermined folder. In the example of FIG. 2, the controller 51 stores the endoscope image named “inspection image 1” in “component 1” of “YYYYMMDD1 measurement”. At the completion of S9, the processing returns to S1 in order to perform measuring of a subsequent object. The measuring is terminated at the completion of measuring of all the objects.

The processing of S1 to S9 constitutes the measuring processing of the first embodiment.

That is, in a measuring method, the image sensor 12 picks up an image of the object, the endoscope image acquired by picking up the image of the object by means of the image sensor 12 is displayed on the display 31, the measurement positions where the object is measured are read from the memory, and the measurement positions on the endoscope image are displayed on the display 31.

Thus, in the endoscope apparatus 1, the measurement points can be easily set.

According to the first embodiment, the endoscope apparatus 1 can efficiently detect an abnormality that may appear on an entire object or a part of the object.

### Modification 1 of the First Embodiment

In the first embodiment, the measuring processing portion P1 cancels the measurement point C2 and newly sets the measurement point C3 in the adjustment processing of the measurement points C1 and C2 (S7). The measuring processing portion P1 may be configured not to cancel the measurement point C2.

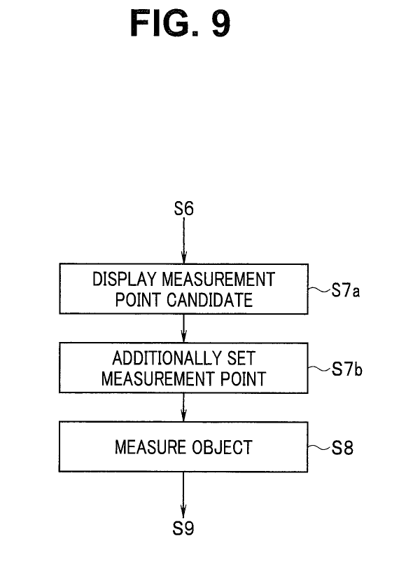

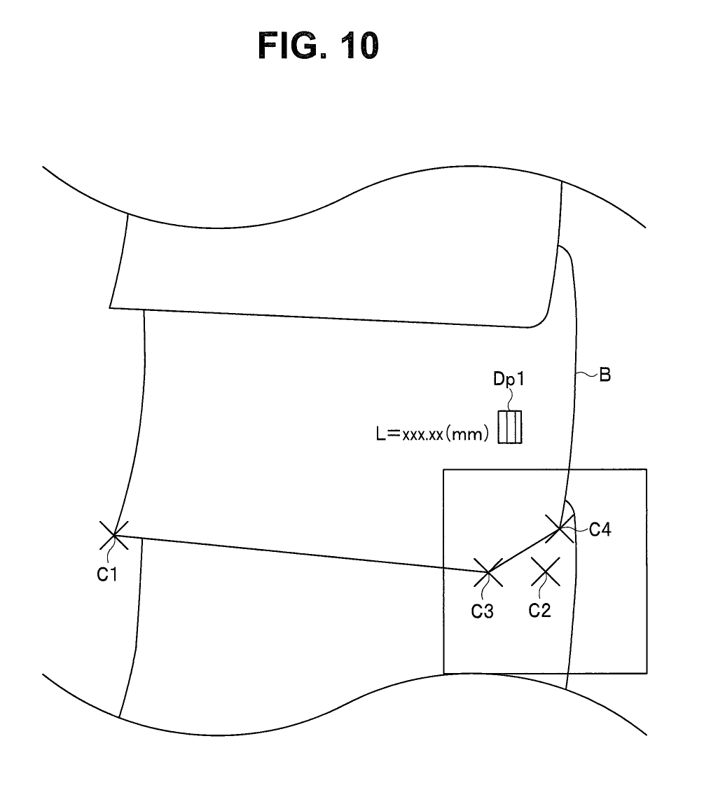

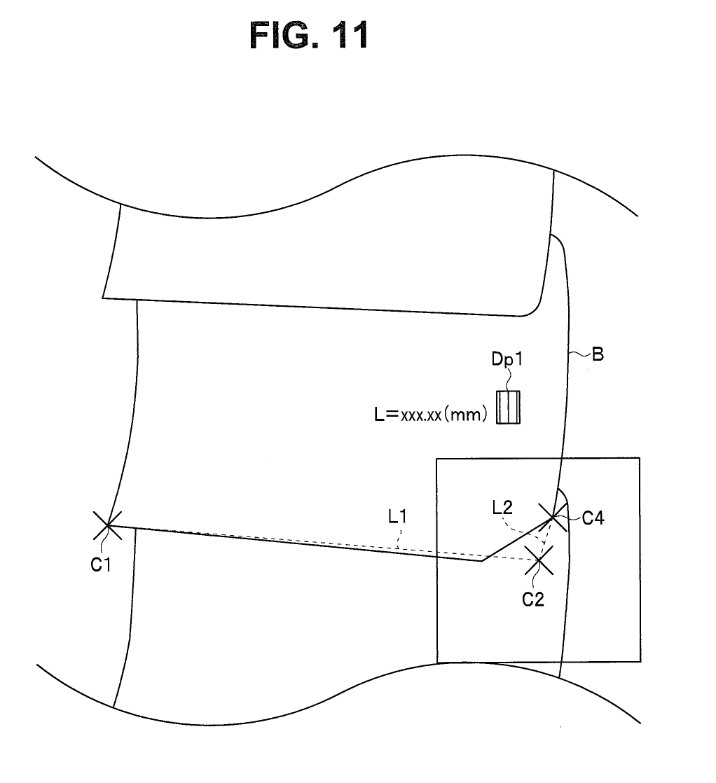

FIG. 9 is a flowchart showing an example of measuring processing on the endoscope image of the endoscope apparatus 1 according to modification 1 of the first embodiment of the present invention. FIG. 10 is a diagram showing an example of measurement point candidates C3 and C4 in the endoscope image of the endoscope apparatus 1 according to modification 1 of the first embodiment of the present invention. FIG. 11 is a diagram showing an example of an additional setting of the measurement point C4 in the endoscope image of the endoscope apparatus 1 according to modification 1 of the first embodiment of the present invention. In the present modification, an explanation of the same components as components of other embodiments and modifications is omitted.

The controller 51 includes a measuring processing portion P2 (a long dashed double-short dashed line in FIG. 1). Processing of the measuring processing portion P2 is different from the processing of the measuring processing portion P1 in the adjustment processing of the measurement points (S7).

The processing of S1 to S6 is identical to the processing of the first embodiment and thus an explanation of the processing is omitted.

The measurement point candidates are displayed (S7a). As shown in FIG. 10, the controller 51 displays the measurement point candidates C3 and C4.

The measurement point is additionally set (S7b). In response to an input of an instruction to select the measurement point candidate C4, the controller 51 additionally sets the measurement point C4.

The object is measured (S8). The controller 51 calculates a distance L1 between the measurement points according to the predetermined arithmetic operation based on the measurement points C1 and C2. Subsequently, the controller 51 calculates a distance L2 between the measurement points according to the predetermined arithmetic operation based on the measurement points C2 and C4. The controller 51 sums the distances L1 and L2 between the measurement points and calculates the distance L between the measurement points. The controller 51 displays the cursor Cs, the spacing distance Z, the indicators Dp1 and Dp2, and the distance L between the measurement points on the display 31.

The processing of S9 is identical to the processing of the first embodiment and thus an explanation of the processing is omitted.

The processing of S1 to S6, S7a, S7b, S8 and S9 constitutes the processing of modification 1 of the first embodiment.

Thus, the endoscope apparatus 1 can additionally set the measurement position and calculate the distance between the measurement positions as well as the additionally set measurement position according to the predetermined arithmetic operation.

### Modification 2 of the First Embodiment

In the first embodiment and modification 1, the measurement point candidates C3 and C4 are extracted from the endoscope image. A size of a current abnormality may be calculated from a past measurement point according to a predetermined arithmetic operation.

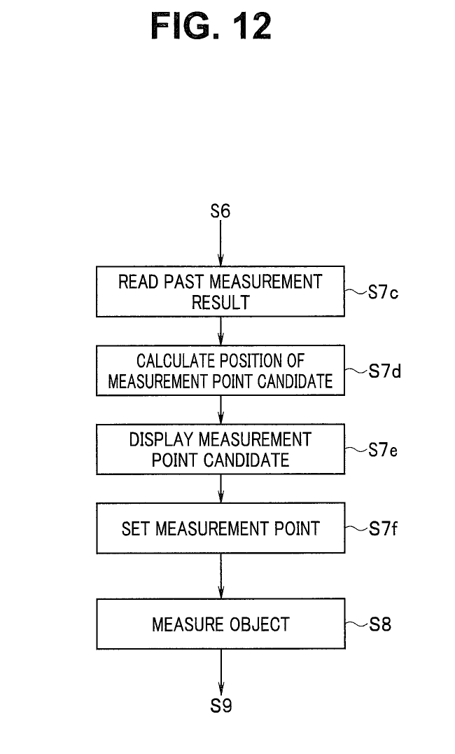

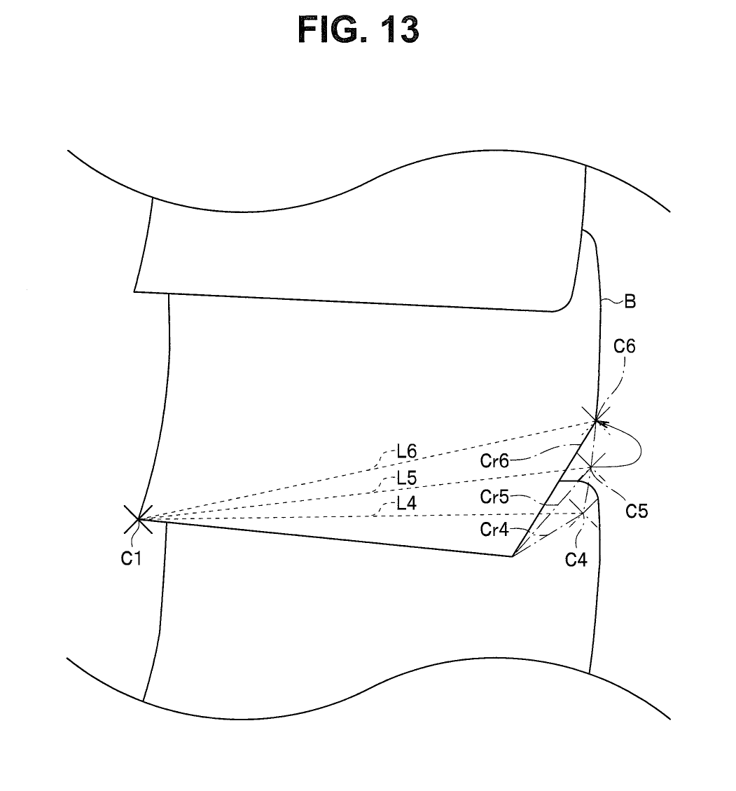

FIG. 12 is a flowchart showing an example of measuring processing in the endoscope image of the endoscope apparatus 1 according to modification 2 of the first embodiment of the present invention. FIG. 13 is a diagram showing an example of a measurement point candidate C6 in the endoscope image of the endoscope apparatus 1 according to modification 2 of the first embodiment of the present invention. In the present modification, an explanation of the same components as components of other embodiment and modification is omitted.

The controller 51 includes a measuring processing portion P3 (a long dashed double-short dashed line in FIG. 1). The processing of the measuring processing portion P3 is different from the processing of the measuring processing portions P1 and P2 in the adjustment processing of the measurement points (S7).

Processing of S1 to S6 is identical to the processing of the measuring processing portions P1 and P2 and thus an explanation of the processing is omitted.

A past measurement result is read (S7c). The controller 51 reads a past measurement result of the object. FIG. 13 shows an example in which damage Cr4 is found in a second previous measurement and damage Cr5 is found in a previous measurement. In the example of FIG. 13, the controller 51 reads measurement results of the measurement point C4 for the damage Cr4, a distance L4 between the measurement points, a measurement point C5 for the damage Cr5, and a distance L5 between the measurement points.

A position of the measurement point candidate is calculated (S7d). The controller 51 calculates a position of the measurement point candidate C6 according to the predetermined arithmetic operation. The measurement point candidate C6 is calculated by a calculating a movement amount of the measurement point C5 per unit time period from the measurement point C4 and multiplying the movement amount per unit time period by a time period from the measurement of the measurement point C5 to a current time. Note that the measurement point candidate C6 may be calculated by another operation method.

The measurement point candidate is displayed (S7e). As shown in FIG. 13, the controller 51 displays the measurement point candidate C6.

The measurement point is set (S7f). When the user inputs an instruction to select the measurement point candidate C6, the controller 51 sets the measurement point C6. Note that, when the measurement point C6 is deviated from the object, a position of the measurement point C6 may be adjusted by inputting an instruction to the instruction input section.

The object is measured (S8). The controller 51 calculates a distance L6 between the measurement points according to the predetermined arithmetic operation based on the measurement points C1 and C6. The controller 51 displays the cursor Cs, the spacing distance Z, the indicators Dp1 and Dp2, and the distance L between the measurement points on the display 31.

The processing of S9 is identical to the processing of the measuring processing portions P1 and P2 and thus an explanation of the processing is omitted.

The processing of S1 to S6, S7c to S7f, S8 and S9 constitutes the processing of modification 2 of the first embodiment.

That is, the measuring processing portion P3 stores the measurement position associated with the inspection date in the memory and calculates the measurement position candidates according to the predetermined arithmetic operation based on multiple inspection dates and measurement positions that are stored in the memory.

Thus, in the endoscope apparatus 1, the measurement point C6 can be more easily set.

### Modification 3 of the First Embodiment

In the measuring processing of the modifications 1 and 2 of the first embodiment, the previous measurement points are read for the object (S1) and the measurement points are displayed (S2). A reference measurement point may be read and multiple objects may be measured using the reference measurement point.

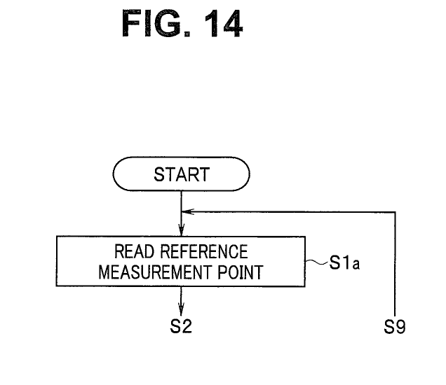

FIG. 14 is a flowchart showing an example of the measuring processing of the endoscope apparatus 1 according to modification 3 of the first embodiment of the present invention. In the present modification, an explanation of the same components as components of other embodiments and modifications is omitted.

The controller 51 includes a measuring processing portion P4 (a long dashed double-short dashed line in FIG. 1). In the measuring processing portion P4, the reference measurement point is read and a plurality of objects are measured using the reference measurement point.

The reference measurement point is preset according to the object and is stored in the memory card C.

An operation of the present modification will be described below.

The reference measurement point is read (S1a). The controller 51 reads the reference measurement point from the memory card C.

Processing of S2 to S6 is identical to the processing of the measuring processing portions P1 to P3 and thus an explanation of the processing is omitted.

The processing of S1a and S2 to S9 constitutes the processing of modification 3 of the first embodiment.

That is, the measuring processing portion P4 reads a reference measurement position, displays the reference measurement position on the display 31, and moves the object on the endoscope image so as to bring a measured portion of the object close to the reference measurement position.

Thus, in the endoscope apparatus 1, each of the plurality of objects can be easily measured using the reference measurement point.

In modification 3, the reference point is read from the memory card C. If the reference measurement point is left in a RAM region provided in the controller 51, the information on the reference measurement point may be read as a past measurement point.

### Second Embodiment

In the first embodiment and modifications 1 to 3, the inspection image is stored in the folder created in advance by the user. A folder configured to store an inspection image may be created by a controller 51 according to contents of measurement.

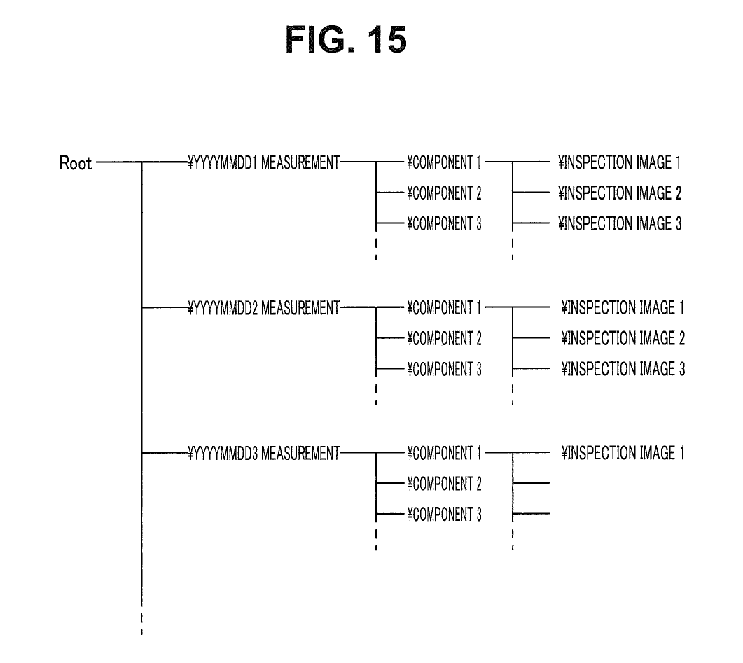

FIG. 15 is a diagram showing an example of a folder hierarchical structure of an endoscope apparatus 1 according to a second embodiment of the present invention. In the present embodiment, an explanation of the same components as components of other embodiments and modifications is omitted.

The controller 51 includes a folder creating portion P5 (a long dashed double-short dashed line in FIG. 1).

The folder creating portion P5 creates a folder configured to store the inspection image.

After reading the measurement point, the folder creating portion P5 creates the folder configured to store the inspection image, according to an inspection date and a read component name. For example, as shown in FIG. 3, a measurement point included in an inspection image 1 of a component 1 of YYYYMMDD2 is read from a memory card C on an inspection date of YYYYMMDD3, the measurement point being stored in a past measurement. At this point, the controller 51 creates a folder of “YYYYMMDD3 measurement” and “component 1”. After the completion of a measurement of an object, the controller 51 writes measurement information, which is acquired by the measurement, in “YYYYMMDD3 measurement”, “component 1”, and “inspection image 1”.

Subsequently, the controller 51 reads a measurement point of an inspection image 2 of the component 1 of YYYYMMDD2, measures the component 1, and then writes measurement information, which is acquired by the measurement, in “YYYYMMDD3 measurement”, “component 1”, and “inspection image 2”. After the completion of the measurement of the component 1, the controller 51 measures a component 2 and a component 3 and stores inspection images.

That is, a memory includes folders of a hierarchical structure and the folder creating portion P5 creates the folders for the object in the memory.

In the second embodiment, the endoscope apparatus 1 can conduct an inspection based on information stored in a previous inspection, store a measurement result in the folder created by the controller 51, and efficiently measure the object.

### Modification 1 of the Second Embodiment

In modifications 1 and 2 of the first embodiment and the second embodiment, the controller 51 reads the measurement points from the previous inspection image before measuring the object. Reference data for reading the measurement points may be created in advance and stored in the memory card C.

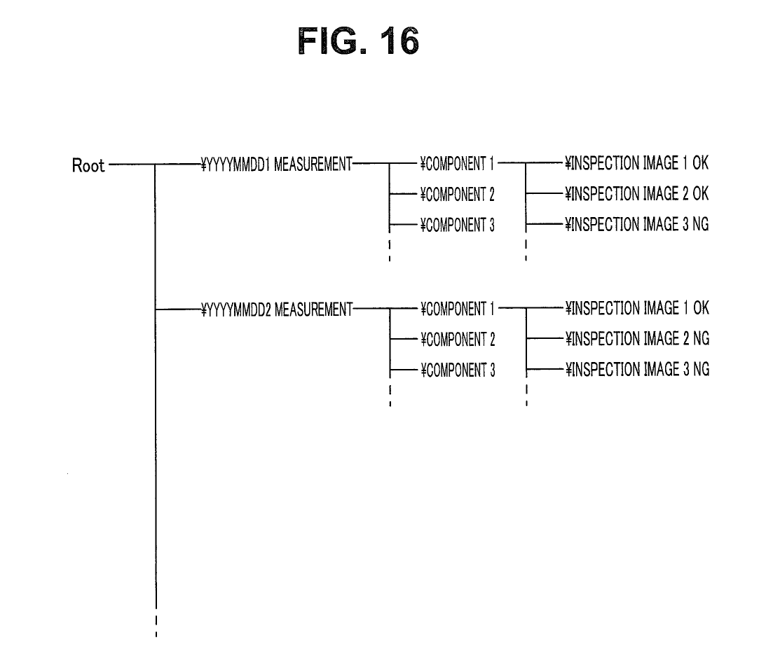

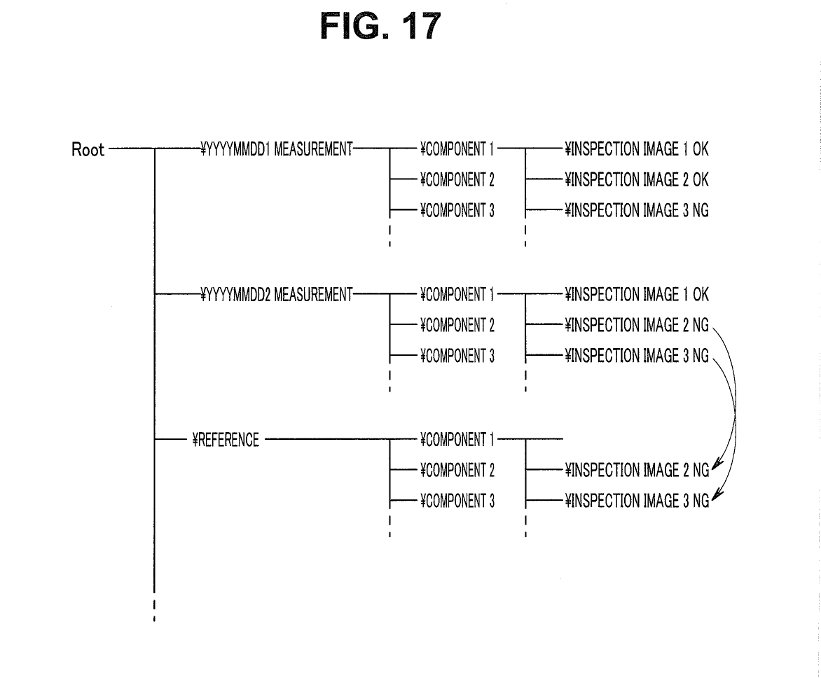

FIGS. 16 and 17 are diagrams showing examples of a folder hierarchical structure of the endoscope apparatus 1 according to modification 1 of the second embodiment of the present invention. In the present modification, an explanation of the same components as components of other embodiment and modification is omitted.

The controller 51 includes a reference data generating portion P6 (a long dashed double-short dashed line in FIG. 1).

The controller 51 generates a measurement result file named according to a measurement result and stores the measurement result file in the folder. In the example of FIG. 16, if the measurement results are OK, the controller 51 stores the measurement results with file names having identification characters “OK”, e.g., “inspection image 1 OK” and “inspection image 2 OK” in the folder, whereas if the measurement results are not OK, the controller 51 stores the measurement results with file names having identification characters “NG”, e.g., “inspection image 3 NG” in the folder.

The controller 51 generates the reference data through processing of the reference data generating portion P6 by a time of start of a subsequent inspection after the end of a previous inspection. For example, as shown in FIG. 17, the controller 51 copies a folder structure of “YYYYMMDD2 measurement” in which a previous measurement result is stored, and then the controller 51 creates a “reference” folder. After that, the controller 51 extracts files with identification characters “NG” from a “YYYYMMDD2 measurement” folder and makes copies in respective folders in the “reference” folder.

The reference data generating portion P6 generates the reference data including the measurement positions, according to the object and measurement results stored in the memory.

Thus, in the endoscope apparatus 1, the measurement point can be read from the inspection image in the “reference” folder.

In the embodiments and the modifications, when an instruction indicating an OK measurement result is inputted in S4 (S4: YES), the processing advances to S9 so as to store the inspection image. When the OK inspection image is not stored, the processing may return to S1 from S4.

In the embodiments and modifications, the measurement results are stored in the memory card C. The measurement results stored in the memory card C may be stored in a server Sv instead through an information terminal Pc. Alternatively, the endoscope apparatus 1 may be connected to the server Sv via the external I/F 41 through a network N so as to read or write various kinds of information such as measurement results in the server Sv.

In the embodiments and the modifications, the memory is the memory card C. The memory is not limited to the memory card C. The memory may be, for example, the memory 53, the information terminal Pc, the server Sv or other external memories.

In the examples of the embodiments and the modifications, the measurement positions are described as coordinate information on the measurement points. Coordinate information on measurement lines may be used instead. In this case, the measuring processing portions P1 to P6 display a measurement line image at the measurement positions on the endoscope image. For example, the measurement points C1 and C2 may be used as coordinate information on the measurement line and a measurement line image CL (a broken line in FIG. 4) connecting the measurement points C1 and C2 may be displayed.

Moreover, according to a zoom range of the endoscope image, the coordinate information on the measurement points may be corrected and the measurement line may be scaled up or down. After the measurement line is displayed, the coordinate information on the measurement points may be corrected according to a movement of the endoscope image and then the measurement line may be displayed accordingly.

The present invention is not limited to the foregoing embodiments and may be changed or modified in various ways without changing the scope of the present invention.

The present invention can provide the endoscope apparatus and the measuring method so as to efficiently detect an abnormality that may appear on an entire object or a part of the object.

What is claimed is:

1. An endoscope apparatus comprising:
an image sensor configured to pick up an image of an object;
a display configured to display an endoscope image acquired by picking up the image of the object by means of the image sensor; and
a controller configured to read, from a memory, measurement positions for measuring the object and display the measurement positions with the endoscope image on the display.

2. The endoscope apparatus according to claim 1, wherein the measurement positions are coordinate information on a measurement point, and
the controller displays a measurement point image at each of the measurement positions on the endoscope image.

3. The endoscope apparatus according to claim 1, wherein the measurement positions are coordinate information on a measurement line, and
the controller displays a measurement line image at the measurement positions on the endoscope image.

4. The endoscope apparatus according to claim 1, wherein the measurement positions are stored in the memory by the controller, and
the controller reads, from the memory, the measurement positions stored in past in the memory and displays the measurement positions with the endoscope image on the display.

5. The endoscope apparatus according to claim 1, wherein the image sensor acquires an object image including a parallax, and
the controller calculates a spacing distance from the image sensor at each of the measurement positions to the object according to a predetermined arithmetic operation based on the object image including the parallax, and displays the spacing distance on the display.

6. The endoscope apparatus according to claim 1, wherein the controller sets a predetermined search region in the endoscope image, detects a measurement position candidate in the predetermined search region, and displays the measurement position candidate on the display.

7. The endoscope apparatus according to claim 6, wherein the controller is capable of displaying a partially enlarged image of the endoscope image including the measurement positions, and
an area of the predetermined search region changes with a magnification of the partially enlarged image.

8. The endoscope apparatus according to claim 1, wherein the controller calculates a distance between the measurement positions according to a predetermined arithmetic operation and displays the distance between the measurement positions on the display, the distance between the measurement positions being a distance between a plurality of measurement positions.

9. The endoscope apparatus according to claim 8, wherein the controller additionally sets one of the measurement positions and calculates the distance between the measurement positions including the additionally set measurement position according to the predetermined arithmetic operation.

10. The endoscope apparatus according to claim 1, wherein the controller stores, in the memory, the measurement positions associated with inspection dates and calculates a measurement position candidate according to a predetermined arithmetic operation based on the inspection dates and the measurement positions that are stored in the memory.

11. The endoscope apparatus according to claim 1, wherein the controller reads a reference measurement position, displays the reference measurement position on the display, and brings a measured portion of the object to the reference measurement position by moving the object on the endoscope image.

12. The endoscope apparatus according to claim 1, further comprising a folder creating portion,
wherein the memory includes folders of a hierarchical structure, and
the folder creating portion creates the folders for the object in the memory.

13. The endoscope apparatus according to claim 1, further comprising a reference data generating portion,
wherein the reference data generating portion generates reference data including the measurement positions according to the object and a measurement result stored in the memory.

14. A measuring method comprising the steps of:
picking up an image of an object by means of an image sensor;
displaying an endoscope image on a display, the endoscope image being acquired by picking up the image of the object by means of the image sensor; and
reading, from a memory, measurement positions for measuring the object and displaying the measurement positions on the endoscope image on the display.
